(19) United States
(12) Patent Application Publication
(10) Pub. No.: US 2014/0266691 A1
(43) Pub. Date: Sep. 18, 2014

(54) DYNAMIC PROVISIONING OF PENDANT LOGIC IN EMERGENCY ASSISTANCE SYSTEMS

(71) Applicant: SAFERAGING, INC., Reston, VA (US)

(72) Inventors: John McKINLEY, Great Falls, VA (US); Christopher WILLIAMS, Herndon, VA (US)

(21) Appl. No.: 13/840,116

(22) Filed: Mar. 15, 2013

(51) Int. Cl. G08B 25/01

(52) U.S. Cl. CPC G08B 25/016
USPC 340/539.11

(57) ABSTRACT

A system and method for provisioning logic to a pendant in an emergency assistance system is provided. This can include receiving logic for operating a pendant from a component of an emergency assistance system over a network, storing at least a portion of the logic in a memory, and executing at least the portion of the logic to detect and report one or more events to the emergency assistance system.

### CROSS-REFERENCE TO RELATED APPLICATIONS

This application relates to co-pending U.S. patent application Ser. No. ______, entitled “MULTIPLE-RADIO PENDANTS IN EMERGENCY ASSISTANCE SYSTEMS,” filed Mar. 15, 2013, co-pending U.S. patent application Ser. No. ______, entitled “AUTOMATED EVENT SEVERITY DETERMINATION IN AN EMERGENCY ASSISTANCE SYSTEM,” filed Mar. 15, 2013, co-pending U.S. patent application Ser. No. ______, entitled “EVENT DETECTION AND REPORTING USING A GENERAL PURPOSE PROCESSOR AND A HARDENED PROCESSOR,” filed Mar. 15, 2013, and co-pending U.S. patent application Ser. No. ______, entitled “HIGH RELIABILITY ALERT DELIVERY USING WEB-BASED INTERFACES,” filed Mar. 15, 2013, all of which are assigned to the assignee hereof, and the entireties of which are herein incorporated by reference for all purposes.

### BACKGROUND

Emergency assistance systems typically include one or more wearable pendants or wall-mounted devices that allow a user to indicate an emergency by pushing a button on a wearable pendant or a wall-mounted device. The wearable pendant or wall mounted device can communicate a button push event with an on-site event detecting system. The event detecting system can forward the event and/or related information, such as an identifier or location of the event detecting system, to a remotely-located centralized station for determining whether to dispatch assistance. The event detecting system, or one or more devices coupled thereto, can allow for audio communication between the centralized station and the site via telephone line to attempt voice communication with the person that pressed the button (e.g., to determine whether assistance is desired).

Advances in technology have enabled emergency assistance systems that allow for communications between the event detecting system and one or more pendants, including voice communications, over more wireless network technologies, such as WiFi (e.g., wireless local area network (WLAN) or other technology based on IEEE 802.11 standards). Pendant functionality, however, is typically limited to simple functionality of detecting/reporting button pushes and allowing audio communications. Thus, the logic for performing these tasks is typically implemented in a dedicated hardened processor. In addition, these pendants only detect the active event of pushing the button, and do not allow for consideration of emergency situations where the person wearing the pendant is unable to engage the button.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to providing a device installed at a site for monitoring by an emergency assistance system that utilizes a general purpose computer, processor, or other device that allows dynamic provisioning of logic, to provide event detection and reporting functionality. In an example, the device can receive logic including functionality specific to a profile configured for a person who is to use the device. The logic can be defined and created at a remote location, and the device can receive the logic by communicating over one or more networks. Thereafter, the device can operate in the emergency assistance system based on the received logic. In one example, this allows for robust specification of functionality defined for pendants, which can be modified based on a profile corresponding to the person who is to wear the pendant.

In this example, pendants described herein can be enhanced to allow for detecting falls by using various components in the pendant, monitoring for inactivity, monitoring environment parameters such as room temperature, triggering local alarming, providing audio reminders, and/or the like. Such aspects of an enhanced wearable pendant, however, may be customized for the person to wear the pendant as different people (or groups of people) may have different detected measurements that should trigger events, different concerns that should be monitored, different preferences for local alarming, different reminder scheduling, etc. Thus, pendants that receive dynamic provisioning of logic specific to the person allow for tailoring the pendants to the person's needs, which can also change over time and can be accommodated by provisioning modified logic to the pendant.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIG. 1 is an aspect of an example emergency assistance system supporting event detection and reporting.

FIG. 2 is an aspect of an example system for provisioning logic to devices in an emergency assistance system.

FIG. 3 is an aspect of example pendant in an emergency assistance system.

FIG. 4 is an aspect of an example methodology for obtaining and executing logic for operating a pendant in an emergency assistance system.

FIG. 5 is an aspect of an example methodology for provisioning logic to a pendant in an emergency assistance system.

FIG. 6 is an aspect of an example methodology for executing provisioned pendant logic in an emergency assistance system.

FIG. 7 is an aspect of an example methodology for executing logic to detect time related events in an emergency assistance system.

FIG. 8 is an aspect of an example system in accordance with aspects described herein.

FIG. 9 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to a device in an emergency assistance system, such as a wearable pendant, a wall-mounted device, a passive activity sensor, and/or the like, that uses a general purpose computer or processor to provide event detection and reporting functionality. For example, wearable pendants can include various form factors, such as a pendant with a lanyard for wearing around the neck, a watch form factor for wearing on a wrist (e.g., where the watch can function as a watch and also include the pendant or components thereof), etc. In this regard, logic for performing event detection, reporting, etc. can be dynamically provisioned to the device and/or customized according to one or more profiles, events, or other information. This allows for robust and contextual event detection and reporting based on defined or determined parameters regarding a person that uses the device, whether it is a wearable pendant, a wall-mounted device, a passive activity sensor, etc.

In an example, event detection and reporting logic can be defined for a pendant based on measuring values from one or more active or passive sensors in the pendant, such as an accelerometer, a digital barometer, a global positioning system (GPS) receiver, a thermometer, and/or the like. Different people can have different values from the sensors that may trigger different events, and thus logic for the pendant is customizable to a person or defined group to which the person is assigned. Similarly, event detection and reporting logic can be defined for a pendant based on available functionality thereof, such as audio playback/recording functionality of the pendant. This logic can also be defined per person or group to provide appropriate functionality during detected events. As the foregoing event detection and reporting logic is customizable, it can be dynamically provisioned to a given pendant to allow operation in accordance with the profile defined for the person using the pendant. In addition, to the extent a measurable parameter regarding the person or pendant changes (e.g., the person is leaving the house, the person becomes disabled, etc.), the logic can be modified and reprovisioned to the pendant. Because the pendant operates using a general purpose computer or processor, the pendant is able to receive and execute the provisioned logic.

As used in this application, the terms “component,” “module,” “system,” “device” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for provisioning logic to an event detecting component. System 100 includes an event detecting component 102 for detecting occurrence of one or more events based on one or more measured parameters. The event detecting component 102 can communicate event information over a network 104 to an event processing component 106, in one example. An alerting component 108 can be provided as well to generate one or more alerts to one or more devices based on the detected event. For instance, where the components 102, 106, and 108 relate to an emergency assistance system, event detecting component 102 can be a wearable pendant, a wall-mounted device, a passive sensor, or other mechanism deployed to detect one or more events related to a person at the site of deployment (e.g., in a home of the person, in an assisted-living facility at which the person is resident, etc.). Event processing component 106 processes events detected by the event detecting component 102 and determines whether to send one or more alerts related to the events using alerting component 108, such as an alert to a monitoring station at or near where the event detecting component 102 is deployed, an alert to emergency dispatch services, and/or the like.

For example, network 104 can include a collection of nodes communicatively coupled with one another via one or more components (e.g., switches, routers, bridges, gateways, etc.), which can include, or can include access to, an Internet, intranet, etc. In addition, in an example, event processing component 106 and alerting component 108 can each be, or can collectively include, one or more servers purposed with performing at least a portion of the described functionalities. Thus, in one example, one or more of the components 106 or 108 can be distributed among multiple servers within network 104 in a cloud computing environment.

Event detecting component 102 can utilize a general purpose computer or processor to execute the event detection logic, and the logic can be updatable. Thus, for example, system 100 also includes a logic provisioning component 110 for providing updated logic to the event detecting component 102 via network 104. In an example, the logic can be provisioned to an on-site event detecting system at the site of the event detecting component 102 (or multiple components), for providing to the event detecting component 102. Event detecting component 102 can include a logic receiving component 112 for obtaining and/or storing the logic from logic provisioning component 110, and a logic executing component 114 for performing functionality of the logic. In an example, logic provisioning component 110 can generate and package updated logic for one or more devices, such as event detecting component 102, based on a change in status of a person to which the one or more devices relate, a specified modification to the logic, and/or the like, and logic provisioning component 110 can transmit a package including the logic to event detecting component 102. Logic receiving component 112 obtains the package with the logic, and can retrieve and/or store the logic. In an example, logic receiving component 112 can verify that the package and/or related logic is valid (e.g., by performing a cyclic redundancy check (CRC), verifying a checksum, and/or the like). In one example, the logic is a complete image that can be stored in memory of the event detecting component 102. Logic executing component 114 executes the received logic to provide desired functionality. Moreover, in an example, logic receiving component 112 can confirm receipt of the logic to logic provisioning component 110 in response (e.g., based on the validity verification).

As described, for example, the event detecting component 102 can include various components that allow for robust detection of certain events. For example, a physically active person may have different event detection parameter thresholds than a sedentary person, though both can use an event detecting component 102 in an emergency assistance system. Thus, profiles having customized parameter thresholds can be defined, and logic related to providing event detection around the profiles can be provisioned to the event detecting component 102. Moreover, logic provisioning component 110 can define and/or provision logic to event detecting component 102 that is related to context information inferred regarding the person (e.g., a location or a change thereof). In yet other examples, general logic for event detecting components 102 can be modified and provisioned thereto (e.g., updated general functionality, such as power management logic). In addition, in an example, event processing component 106, alerting component 108, and logic provisioning component 110, can each be or collectively include one or more servers purposed with performing at least a portion of the described functionalities. Thus, in one example, one or more of the components 106, 108, or 110 can be distributed among multiple servers within network 104 in a cloud computing environment.

FIG. 2 illustrates an example system 200 for provisioning logic to one or more devices of an emergency assistance system. System 200 includes a logic provisioning component 110 for updating logic of one or more pendants 202, one or more wall-mounted devices 204, one or more passive sensors 206, and/or the like, installed at one or more sites. Logic provisioning component 110 can be part of an emergency assistance system that processes events from pendants 202, wall-mounted devices 204, passive sensors 206, etc., and can send the updated logic via network 104, as described above. Logic provisioning component 110 can include a profile selecting component 208 for allowing selecting of one or more profiles for generating logic to be provisioned to a device of an emergency assistance system (e.g., a pendant, wall-mounted device, passive sensor, etc.), a parameter specifying component 210 for obtaining one or more parameters related to detecting events in logic to be provisioned to the device, a context update determining component 212 for detecting an update in context for the device, and a logic defining component 214 for generating pendant logic based at least in part on a selected profile, a specified parameter, and/or an updated context.

According to an example, profile selecting component 208 can facilitate selecting a profile for defining logic to deliver to a pendant or other device of an emergency assistance system. For example, profile selecting component 208, in one example, can obtain input from an interface regarding a profile selected for a person using the device of the emergency assistance system. The selected profile can include threshold values for certain parameters related to determining whether to detect and report an event in the emergency assistance system. The parameters can be measurable by the device of the emergency assistance system. For example, pendant 202, as described further herein, can include various mechanisms that measure values for the parameters, and can compare the values to the thresholds as part of the logic in determining whether to trigger an event.

Parameter specifying component 210 can allow for defining specific thresholds for the parameters to trigger an event. Context update determining component 212 can detect an update to information about the person using the device, such as a change in location, a change in physical status, a change in age, a change in medication schedule, and/or the like. Such changes can be determined based on parameter measurement (e.g., GPS coordinates to determine change in location), anticipated changes (e.g., inferring location change from calendar appointment), and/or the like. In any case, logic defining component 214 defines logic for the devices to meet needs of the person based on the profile, specific parameters, context update, etc., and logic provisioning component 110 transmits the logic to pendant 202, wall-mounted device 204, and/or passive sensor 206 via network 104. The device(s) can accordingly update the logic and continue to operate in the emergency assistance system. In one example, a portion of the logic can be predefined for certain profiles, and logic defining component 214 can obtain logic for a selected profile for providing to the device (e.g., as obtained or further modified based on parameter selections of parameter specifying component 210).

In a specific example, profile selecting component 208 can be used to associate an “active senior” profile to a person to use one or more of the pendant 202, wall-mounted device 204, and/or passive sensor 206. The “active senior” profile can have associated parameter thresholds for notifying of an event, where the parameters depend on functionality of the pendant 202, wall-mounted device 204, and/or passive sensor 206. In one example, pendant 202 can include components for fall detection, such as an accelerometer, digital barometer, and/or the like. For the “active-senior” profile, for example, thresholds for measurements from an accelerometer may be set higher than for a “sedentary senior” profile as more movement from an “active senior” may be expected. In another example, allowed motion thresholds for a passive sensor 206 that detects motion can be higher for the “active senior” than for the “sedentary senior.” Profile selecting component 208 can allow for associating additional profiles to the person, which can be specific to known context information of the person (e.g., a roaming profile for a person that is detected as, or otherwise determined to be, out of range of one or more components of the emergency assistance system, etc.), generic to the device (e.g., power management profiles), and/or the like.

In another example, parameter specifying component 210 can be used to set specific parameter thresholds for a given person. In this regard, a profile can be created specific to the person. In one example, a profile can first be selected using profile selecting component 208, and then parameters can be individually modified, if desired, using parameter specifying component 210. In some examples, profile selecting and/or parameter specification can be automated based on detecting a context of the person by context update determining component 212. For example, the context update determining component 212 can obtain information regarding a context change from the pendant 202 (e.g., a GPS detected location outside a site of the emergency assistance system), from another component of the emergency assistance system, and/or the like.

In one specific example, context update determining component 212 can determine that the person has an appointment outside of the site where the emergency assistance system is located (e.g., based on a calendar for the person inputted into context update determining component 212 or another component of the emergency assistance system). Accordingly, profile selecting component 208 can obtain a roaming profile for the pendant 202 of the person, which can be an add-on to a current profile or otherwise modify parameters of the current profile. Logic defining component 214 can define logic for the pendant 202 based on the roaming profile, and logic provisioning component 110 can send the logic to pendant 202, which can modify its current logic and use the received logic. For example, a roaming profile may have different settings for a speaker on the pendant 202 (e.g., an increased volume for notifying of detected emergencies).

In another specific example, context update determining component 212 can detect a change in a parameter related to the person, such as an indication that the person has become physically disabled. In this regard, profile selecting component 208 can select a new profile for the person (e.g., a “disabled senior” profile where the person previously has an “active senior” profile). Logic defining component 214 can generate logic for one or more of pendant 202, wall-mounted device 204, or passive sensor 206 based on the detected change, and logic provisioning component 110 can send the logic to the pendant 202, wall-mounted device 204, or passive sensor 206 over network 104. In addition, logic provisioning component 110 can include a mechanism for performing a CRC or checksum verification at the pendant 202, wall-mounted device 204, passive sensor 206, etc. to verify whether the logic was properly received (e.g., not corrupted). Thus, logic provisioning component 110, in one example, can await a receipt confirmation from the pendant 202, wall-mounted device 204, passive sensor 206, etc. to determine the logic was sent. Where such a confirmation is not received after a predetermined time, or a confirmation is received indicate corrupted logic, logic provisioning component 110 can perform one or more additional functions, such as attempt retransmission of the logic, alert one or more components of an emergency assistance system of the failed receipt, etc.

FIG. 3 illustrates an example system 300 for provisioning logic to a pendant in an emergency assistance system. System 300 includes a pendant 202 and a logic provisioning component that provides logic to the pendant 202 for operation thereof. Pendant 202 can include one or more of the various components depicted to facilitate event detection and reporting by the pendant 202. For example, pendant 202 can include an emergency button 302 for indicating an emergency by activating the button, a processor 304, which can include a general purpose processor, for executing logic described herein for event detection and reporting, and a memory 306 to store instructions for executing the logic, data, or other information related to event detecting and reporting. Pendant 202 can also include a main radio 308, such as a WiFi, cellular, Bluetooth, ZigBee, or similar radio to facilitate reporting events or other information to one or more components of an emergency assistance system, and a secondary radio 310 to additionally or alternatively communicate with one or more components of the emergency assistance system (e.g., when the main radio 308 experiences communication failure). For example, the secondary radio 310 can communicate using a different frequency spectrum, protocol or technology (e.g., 2.4 gigahertz (GHz)), etc. than the main radio 308.

Pendant 202 can also include a speaker 312 to render audio tones or messages, which can be a local piezo buzzer or similar mechanism, a microphone 314 to record audio, and a light emitting diode (LED) array 316, or similar illumination source, for displaying light for a detected event. Pendant 202 may also include a battery 318 to power the pendant, an accelerometer 320 to measure acceleration of the pendant 202, a digital barometer 322 to measure height change of the pendant 202, a thermometer 324 to measure ambient temperature, a GPS receiver 326 to determine a GPS position of the pendant 202, and/or a power management component 328 for controlling components of the pendant 202 based on one or more parameters of a power management scheme provisioned to the pendant 202. Pendant 202 also includes a logic receiving component 112 for obtaining logic regarding operating the various components, and a logic executing component 114 for employing processor 304 and/or memory 306 to execute functionality of the obtained logic. For example, the logic executing component 114 can be a software application executing on processor 304.

In this regard, logic provisioned by logic provisioning component 110, and received by logic receiving component 112 (e.g., over a network, as described), can define operation of the pendant 202 with respect to its various components. As described, in an example, logic receiving component 112 can confirm delivery of the logic and/or that the received logic is not corrupted, etc. The logic can include not only for detecting events, but also for reporting or otherwise notifying of the events, as described above and further herein. For example, the logic can define thresholds for measured parameters of the components to facilitate fall detection, inactivity (or over-activity) monitoring, environmental monitoring, local alarming, reminder playback, audio recording, and/or the like. The logic can be defined based on a specified profile or parameters and/or can be updated based on a detected change in context of the pendant 202, as described. In one specific example, the logic can specify parameter thresholds for fall detection, which can include detecting an acceleration measurement above a threshold via accelerometer 320 combined with a height adjustment measurement over a threshold via digital barometer 322. Where such is detected, main radio 308 and/or secondary radio 310 can communicate a fall detection event to the emergency assistance system, LED array 316 can flash, speaker 312 can sound a tone, and/or the like. The thresholds and reporting functionality can be different for different defined profiles (e.g., profiles based on age or activity level can have different thresholds for detecting the fall, profiles based on actual or anticipated location can have different mechanisms for reporting detected falls, etc., as described).

In another specific example, the logic can specify parameters for activity/inactivity monitoring, which can include inferring activity based on accelerometer 320 measurements, measurements of position over time from GPS receiver 326, etc. The logic can define parameter thresholds for detecting events related to too much activity (over-activity) or inactivity (which may indicate the person is in distress). More inactivity over time may be allowed for a “sedentary senior” than an “active senior.” However, logic may be provided to trigger events related to over-activity at certain times of day (e.g., at night. In addition, in an example, the logic can vary parameter thresholds based on the time of day, which can be specific to the pendant. For example, a minimum threshold for acceleration measurements via accelerometer 320 may be lower midday than overnight, as the person may be assumed to be sleeping overnight. In addition, in an example, the logic can define parameter thresholds for allowed location of the pendant measured by GPS receiver 326 (e.g., to facilitate range fencing of a person where an event is triggered when the pendant is determined to be outside of an allowed location range). In yet another example, the logic can specify parameter thresholds for detecting events based on temperature according to measurements by thermometer 324, which can also be specific for a given pendant. Thus, a lower range of temperature can be acceptable as specified for a person who prefers to keep their house (or other site of emergency assistance system installation) cooler.

Moreover, the logic can define parameters for certain audio playback via speaker 312, such as a reminder to take medicine played at certain times of day. It is to be appreciated that the audio files can be included in the logic or otherwise obtained and stored in memory 306. In another example, the audio can be streamed (e.g., over the main radio 308), and the logic can specify whether to stream audio files or play audio files stored in memory 306. For example, such streamed audio can be similar to the described audio and/or can include real-time event alerts, such as emergency broadcast system alerts, weather advisories near a location of the pendant 202, etc. The delivery mechanism, content, and instructions for playing the audio can all be defined in logic, which is provisioned to pendant 202. In additional examples, the logic can define instructions or parameters for playing audio can be defined based on location of the pendant (e.g., a weather alert), a detected event (e.g., audible tones to indicate a detected fall), a command from the emergency assistance system (e.g., received over a network connection thereto, an event detecting system connected thereto, etc.), and/or the like.

In further examples, the logic can specify parameters related to event reporting, such as: an audio stream, volume, duration, etc. for sounding an alarm on speaker 312 for certain detected events; duration, intensity, pattern, color, etc. for flashing LEDs in LED array 316 for certain detected events; audio sampling duration for microphone 314 based on certain detected events; and/or the like. For instance, the audio sampling data from microphone 314 can be transmitted to the emergency assistance system for playback to personnel, automated triage to determine possible status of the person based on the audio sampling and other event data, etc.

In additional examples, the logic can relate to operating power management component 328 such to conserve power of the battery 318 in certain detected contexts. For example, where battery 318 is low, power management component 328 can disable accelerometer 320, digital barometer 322, thermometer 324, GPS receiver 326, etc. and/or can activate a periodic audio indicator via speaker 312 to notify of the low power state. The power management can be according to one or more defined power management schemes, which are provided in the logic or otherwise provisioned to the pendant 202. In one example, the power management scheme can continue to shutdown components while maintaining power to the emergency button 302 for as long as possible. For example, logic provisioning component 110 can provision the power management scheme logic to the pendant 202 based on an anticipated change in location (e.g., based on a calendar event) and can disable the main radio 308 during the time of the anticipated change in location, since the pendant 202 is anticipated to be outside of the range of the emergency assistance system during this time. In addition, the logic can define instructions or parameters related to other management events of the pendant 202, such as regular check-in or other health status events related to the pendant 202, uploading of certain historical data to the emergency assistance system (e.g., uploading activity history parameters measured by one or more of the components), systems status information (e.g., battery 318 level, current location of the pendant 202, etc.), and/or the like.

Moreover, in an example, the logic can define parameter thresholds for detecting a lost pendant event; for example, this can include detecting that the pendant 202 has not moved location over a certain period of time via GPS receiver 326 measurements, detecting the pendant 202 has been in a low power state during this time, determining that the pendant 202 is not in radio range (e.g., no connection via main radio 308), and/or the like. The logic can also include reporting for the lost pendant event (e.g., activate a tone over speaker 312, display lights on LED array 316, etc.). In additional examples, pendant 202 can communicate with other devices, such as a vital statistic monitoring device (e.g., a sphygmomanometer, pulse rate detector, internal thermometer, etc.) to detect and/or report events related thereto.

In yet another example, the logic can specify parameters for determining when to use secondary radio 310 for communications with an on-site component of the emergency assistance system in addition to or instead of the main radio 308. For example, the logic can specify using both main radio 308 and secondary radio 310 for communicating certain sensitive data, such as an activation event for emergency button 302. In addition, for example, the logic can specify using secondary radio 310 to communicate with the on-site component when the main radio 308 experiences communication failure or is otherwise unresponsive.

Moreover, for example, the logic can specify instructions for maintaining historical values of measurements from one or more of the components. This can assist in providing information for determining a severity of an event. In one specific example, a location history combined with a fall detection can indicate a severity where the location before the fall is outside of the facility. In addition, maintaining the historical values can allow for other data analysis, such as determining an activity level over a period of time (e.g., based on accelerometer 320 measurements, location changes obtained from GPS receiver 326 or radio 308 or 110 triangulation, etc.).

The above are examples of different pendant logic that can be defined and provisioned to pendant 202 via logic provisioning component 110, and are not intended to limit possible logic that can be defined for the components of a pendant 202 and provisioned to the pendant 202. In some examples, portions of the updated logic can be sent to the pendant 202 via logic provisioning component 110, such as program modules, configuration files, etc. such that logic receiving component 112 can obtain the portion of updated logic, and copy necessary portions to memory 306 to effectuate changes to the logic executed by logic executing component 114. In one example, logic can be modified to add a component for detecting a certain event (e.g., add the digital barometer 322 to the current fall detection algorithm), and can be provisioned to the pendant via logic provisioning component 110. As described, the logic can be context specific such that changes detected in a context or environment related to a person can result in generation and transmission of new logic from logic provisioning component 110, which can be received by logic receiving component 112, stored, and/or updated for use by logic executing component 114.

Referring to FIGS. 4-7, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for obtaining provisioned logic in an emergency assistance system. At 402, logic for operating a pendant can be received over a radio of the pendant. The pendant can operate in an emergency assistance system and can include the radio (and/or one or more additional radios), in one example, for communicating information regarding detected events to one or more components of the emergency assistance system. The logic can be received from a component of the system, and can include one or more instructions, configuration parameters, and/or the like that define functionality for detecting and/or reporting events to the emergency assistance system. At 404, at least a portion of the logic can be stored in memory, and at 406, at least a portion of the logic can be executed for detecting and/or reporting one or more events. In this regard, the pendant can function as intended by the provisioned logic, and updates, improvements, or other modifications to the logic can be provisioned remotely from the emergency assistance system to provide more robust and/or customized functionality.

FIG. 5 illustrates an example methodology 500 for provisioning logic to a pendant in an emergency assistance system. At 502, one or more parameter thresholds can be associated with a pendant based on a person to use the pendant. As described, a profile can be selected for the person based on characteristics of that person (e.g., whether the person is active or sedentary, the age of the person, and/or the like). In one example, such characteristics can be inferred based on received data for the person (e.g., a calendar with many events may indicate a more active person). Moreover, the profiles can relate to a current or anticipate context of the person, such as whether the person is or plans to be leaving the range of the emergency assistance system. The profiles can define a set of parameter thresholds (e.g., less sensitive thresholds related to fall detection for active senior than sedentary senior, additional alarming for alternative location profiles, etc.). In another example, at 502, individual parameter thresholds can be specified or otherwise modified from an initial profile to provide further customization.

At 504, logic can be defined for operating the pendant based at least in part on the one or more parameter thresholds. For example, this can include generating executable programmatic instructions for the pendant based on the one or more parameter thresholds and/or specific actions for reporting certain events. Additionally, or alternatively, this can include generating configuration parameters relating to the one or more parameter thresholds or event reporting in a format that can be used by an application executing on the pendant. In this example, the pendant can input the configuration parameters for use with the currently executing application. In any case, the logic is transmitted to the pendant at 506. As described, the logic allows the pendant to determine when and how to detect and/or report certain events. The pendant can receive the logic over a radio, store at least a portion of the logic, and execute the portion of the logic as received.

FIG. 6 illustrates an example methodology 600 for detecting and reporting events in an emergency assistance system. At 602, provisioned logic can be executed. The provisioned logic, as described, can be obtained from a component of the emergency assistance system over an integrated radio. At 604, measurements from a component of a pendant can be detected in a time period. For example, the measurements can be obtained from an accelerometer, digital barometer, thermometer, GPS receiver, etc. At 606, optionally measurements from another component of the pendant can be detected in the time period. The measurements at 604 and 606 can be initiated, for example, based on one or more events, such as a detected change in a measured value of the respective component(s). At 608, it can be detected whether the measurements indicate an event. This can include comparing the measurements to one or more parameter thresholds. If the measurements indicate an event, the event is reported at 610. This can include sending information regarding the event to the emergency assistance system, triggering one or more local event reporting mechanisms of the pendant (e.g., activating lights of a LED array, playing a tone on a speaker, etc.). If the measurements do not indicate an event, the logic is continued to be executed at 602.

In a specific example, at 604, a measurement from an accelerometer in the pendant can be detected, and at 606, a measurement of a digital barometer in the pendant can be detected. The provisioned logic can include parameter thresholds for measurements from the accelerometer and the digital barometer that may, together, indicate a detected fall. Thus, at 608, in this example, it is determined whether the measurements from the accelerometer and digital barometer indicate a fall event. If so, the fall event is reported at 610, which include transmitting information regarding the fall event over the radio to the emergency assistance system, blinking lights in a LED array on the pendant, sounding an alarm on a speaker of the pendant, etc., as defined in the provisioned logic.

In other specific examples, at 604, measurement of an amount of activity over the time period, an ambient temperature or change thereto over the time period, location of the pendant during the time period, etc. can be measured, as described in different example scenarios above. At 608, it can be determined whether the measurement(s) indicate an event, and if so, the event is reported at 610.

FIG. 7 illustrates an example methodology 700 for executing provisioned logic to trigger local events. At 702, the provisioned logic is executed. The provisioned logic, as described, can be obtained from a component of the emergency assistance system over an integrated radio. At 704, a local time can be determined. Thus, in an example, the local time can be measured from an integrated clock and/or otherwise received from the emergency assistance system. At 706, it can be determined whether there is a local even that relates to the current local time. This can be performed by a task scheduler or similar component that allows for specifying times to execute certain events. If there is an event related to the time, the local event can be triggered according to parameter specified in logic at 708. For example, such events can include playing an audio sample reminder at the time (e.g., a reminder to take medicine), detecting movement via an accelerometer (e.g., based on determining an appointment scheduled for the person at the local time), and/or the like.

To provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., cathode ray tube (CRT), liquid crystal display (LCD), light emitting diode (LCD), plasma . . . ), speakers, printers and other computers, among other things.

According to an example, computer 812 can perform the logic defining and provisioning functions, as described. In this example, the processing unit(s) 814 can comprise or receive instructions related to facilitating profile selection or parameter specification, context update detecting, logic defining and provisioning, etc., and/or other aspects described herein. It is to be appreciated that the system memory 816 can additionally or alternatively store such instructions and the processing unit(s) 814 can be utilized to process the instructions. Mass storage 824 can store parameters relating to the available profiles, the parameters and/or related thresholds associated to the various pendants, pendant logic images corresponding to selectable profiles, and/or the like. In addition, computer 812, or a portion thereof, can be used to perform pendant functions, such as receiving and executing provisioned logic, in one example.

FIG. 9 is a schematic block diagram of a sample-computing environment 900 with which the subject innovation can interact. The environment 900 includes one or more client(s) 910. The client(s) 910 can be hardware and/or software (e.g., threads, processes, computing devices). The environment 900 also includes one or more server(s) 930. Thus, environment 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The environment 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can be pendants or other event detection devices that receive logic from server(s) 930, which can include a logic provisioning component, via communication framework 950. The server(s) 930 can, in one example, allow for selecting profiles for the pendants, selecting specific parameters for the pendants, detecting changes to information regarding the pendants, and/or the like, and can transmit related modified logic back to the client(s) 910 via communication framework 950. Associated data stores 960 and 940 can store instructions relating to the logic, one or more profiles, parameters specific to certain pendants, profiles, associated logic, etc., and/or the like.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for provisioning logic to a pendant in an emergency assistance system, comprising:
a processor and a memory;
a logic receiving component for obtaining logic for operating a pendant from a component of an emergency assistance system and storing at least a portion of the logic in the memory; and
a logic executing component for utilizing the processor to perform at least the portion of the logic, wherein the logic is configured to detect and report one or more events based at least in part on parameters measured by one or more components of the pendant.

2. The system of claim 1, wherein the logic receiving component further obtains updated logic for operating the pendant and stores at least a portion of the updated logic in the memory, and the logic executing component utilizes the processor to perform at least the portion of the updated logic.

3. The system of claim 2, wherein the logic receiving component obtains the updated logic based at least in part on communicating a context change related to a person using the pendant.

4. The system of claim 3, wherein the updated logic is defined based at least in part on one or more profiles assigned to the person using the pendant based on the context change.

5. The system of claim 1, further comprising a radio for connecting to a network over which the logic receiving component obtains the logic.

6. The system of claim 5, further comprising a secondary radio for communicating with an on-site component of an emergency assistance system, wherein the logic specifies one or more scenarios for communicating using the secondary radio in addition or alternatively to the radio.

7. The system of claim 1, further comprising an accelerometer and a digital barometer, wherein the logic includes one or more thresholds for parameters measured by the accelerometer and the digital barometer that cause reporting a fall detection event.

8. The system of claim 7, wherein the logic further includes one or more activity thresholds for parameters measured by the accelerometer and the digital barometer that cause reporting an inactivity event or an over-activity event.

9. The system of claim 1, further comprising a speaker, wherein the logic specifies instructions for playing one or more audio files over the speaker at a given time or in response to an event.

10. The system of claim 9, wherein the instructions comprise instructions for streaming the one or more audio files over the network for playing over the speaker.

11. The system of claim 9, wherein the instructions comprise instructions for playing one or more audio files stored in the memory over the speaker based at least in part on a time of day, a detected event, or a command from the emergency assistance system.

12. The system of claim 9, wherein the one or more audio files correspond to an emergency broadcast system alert or a weather advisory.

13. The system of claim 1, further comprising a microphone, wherein the logic specifies a duration for recording an audio sample via the microphone following detecting of a specified event.

14. The system of claim 13, wherein the logic further specifies instructions for uploading the audio sample to the emergency assistance system.

15. The system of claim 1, wherein the logic further specifies instructions for reporting health status of one or more components or uploading a history of component measurements.

16. A method for provisioning logic to a pendant in an emergency assistance system, comprising:
receiving, using a radio, logic for operating a pendant from a component of an emergency assistance system over a network;
storing at least a portion of the logic in a memory; and
executing, using a processor, at least the portion of the logic to detect and report one or more events to the emergency assistance system.

17. The method of claim 16, further comprising:
receiving updated logic for operating the pendant from a component of the emergency assistance system;
storing at least a portion of the updated logic in the memory; and
executing at least the portion of the updated logic instead of the at least the portion of the logic.

18. The method of claim 16, further comprising indicating a detected change in context related to the pendant to the emergency assistance system, wherein the receiving the updated logic is based at least in part on the detected change in context.

19. A system for provisioning logic to a pendant in an emergency assistance system, comprising:
a component for associating one or more parameter thresholds with a pendant, wherein the one or more parameter thresholds are selected based at least in part on a person to use the pendant;
a logic defining component for defining logic for operating the pendant based at least in part on the one or more parameter thresholds; and
a logic provisioning component for transmitting the logic to the pendant.

20. The system of claim 19, wherein the logic provisioning component transmits the logic to the pendant over a network for receipt by a network radio on the pendant.

21. The system of claim 19, further comprising a context update determining component for detecting an update to one or more context parameters related to the pendant, wherein the component associates a different one or more parameter thresholds with the pendant based at least in part on the detected update, the logic defining component defines different logic for operating the pendant based on the different one or more parameter thresholds, and the logic provisioning component transmits the different logic to the pendent.

22. The system of claim 19, further comprising a profile selecting component for associating a profile selected for the person to use the pendant with the pendant, wherein the profile specifies the one or more parameter thresholds.

23. The system of claim 19, further comprising a parameter specifying component for facilitating indicating at least a portion of the one or more parameter thresholds.
